(19) United States
(12) Patent Application Publication
(10) Pub. No.: US 2020/0007072 A1
(43) Pub. Date: Jan. 2, 2020

(54) SYSTEMS AND METHODS FOR SOLAR PANEL CONTROL AND MOUNTING

(71) Applicant: Ron GANGEMI, Auburn, CA (US)

(72) Inventor: Ron GANGEMI, Auburn, CA (US)

(21) Appl. No.: 16/570,872

(22) Filed: Sep. 13, 2019

Related U.S. Application Data
(63) Continuation-in-part of application No. 15/616,927, filed on Jun. 8, 2017, now Pat. No. 10,439,554.

(51) Int. Cl. H02S 20/23; H02H 1/00; H02H 7/20; H02S 40/34

(52) U.S. Cl. CPC H02S 20/23; H02S 40/34; H02H 7/20; H02H 1/0015

(57) ABSTRACT

Embodiments disclosed herein include a solar panel protection and control system and a solar panel mounting system. An example embodiment includes a solar panel mounting system comprising: a top bar; a bottom bar; a first side bar; a second side bar; a plurality of elongated ribs extending between the top bar and the bottom bar, the first and second side bars extending between the top and bottom bars, the top bar, the bottom bar, the first side bar, and the second side bar collectively forming an outer boundary of the mounting system, and the elongated ribs providing support and a location on which a solar panel can be mounted; and a solar panel attached to the plurality of elongated ribs with a flexible adhesive.

### PRIORITY PATENT APPLICATION

This patent application is a continuation-in-part (CIP) patent application drawing priority from U.S. non-provisional patent application Ser. No. 15/616,927; filed Jun. 8, 2017. This present non-provisional patent application draws priority from the referenced patent application. The entire disclosure of the referenced patent application is considered part of the disclosure of the present application and is hereby incorporated by reference herein in its entirety.

### TECHNICAL FIELD

This patent document pertains generally to a mounting system and control system for solar panels, and more specifically to a mounting system for securing solar panels to a composite roof, wherein the solar panels can be thin-film, flexible solar panels.

### BACKGROUND

Due to increasing environmental concerns, new building codes, alternatives to non-renewable and polluting fossil fuels have been investigated. Solar energy has received increasing attention as an alternative renewable, non-polluting energy source, and photovoltaic installations on commercial and residential roofs are becoming increasingly popular. Concerns of excessive roofing material, fire walkways, and roofing membrane penetrations pose a practical and economic burden on conventional means of securing solar photovoltaic panels to buildings and other structures. Conventional mounting systems typically utilize roof-penetrating threaded fasteners to secure solar panels to roof-tops. The associated cost of those parts, along with the added photovoltaic (PV) panel weight, cost of engineering manpower and time required for installation, contributes significantly to the high-cost of photovoltaic systems.

Flexible solar panels are becoming more popular due in part to the reduced manufacturing costs relative to their rigid counterparts. These flexible solar panels can be flexible copper indium gallium selenide (CIGS) thin-film photovoltaic panels, which are manufactured by MiaSolé™ of Santa Clara, Calif. MiaSolé's manufacturing process lays CIGS on a flexible stainless steel substrate and produces all layers of photovoltaic material in a continuous sputtering process, thereby producing efficient thin-film, flexible solar panels. However, the use of flexible solar panels introduces new difficulties for mounting them to a surface such as a roof in part due to the expansion and contraction that occurs due to exposure of the flexible solar panel to the elements. Thus, a need exists for a smart PV panel that optimizes power output and a mounting system for flexible solar panels that reduces the installation burden, minimizes roof penetrations, and ensures that the PV panels are adequately secured to the roof under various environmental conditions.

### BRIEF DESCRIPTION OF THE DRAWINGS

The various embodiments are illustrated by way of example, and not by way of limitation, in the figures of the accompanying drawings in which:

FIG. 1 is a perspective view illustrating a building with a solar panel mounting system having solar panels thereon secured to the roof in accordance with an example embodiment;

FIG. 2 is a front perspective view of a solar panel mounting apparatus of the solar panel mounting system of FIG. 1 with a solar panel coupled thereto;

FIG. 3 is a front perspective view of the solar panel mounting apparatus of FIG. 2 with the solar panel exploded;

FIGS. 4 and 5 are exploded perspective views of the solar panel mounting apparatus of FIG. 2;

FIG. 6 is a bottom view of the solar panel mounting apparatus of FIG. 2;

FIG. 7 is a cross-sectional view taken along line VII-VII of FIG. 1;

FIG. 8 is a close-up of area VIII of FIG. 7;

FIG. 9 is a cross-sectional view taken along line IX-IX of FIG. 1;

FIG. 10 is a close-up of area X of FIG. 9; and

FIG. 11 is an example embodiment illustrating the solar panel auto-populate feature showing how to maximize the solar panel area on a roof using the solar panel mounting system and control system of an example embodiment.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the example embodiments. Accordingly, the invention expressly should not be limited to such exemplary embodiments illustrating some possible non-limiting combination of features that may exist alone or in other combinations of features; the scope of the invention being defined by the claims appended hereto.

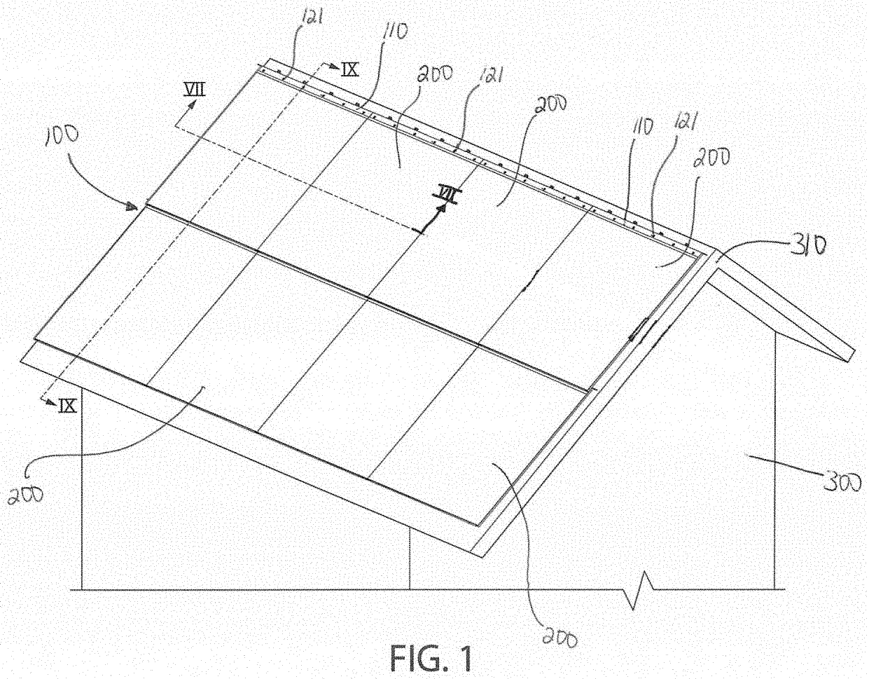

Referring first to FIG. 1, a mounting system 100 for mounting a plurality of solar panels 200 to a roof 310 of a building 300 is illustrated. The mounting system 100 comprises a plurality of mounting apparatuses 110 and one of the solar panels 200 is coupled to each of the mounting apparatuses 110. The mounting system 100 is coupled to the roof 310 with a minimum of penetrations into the roof to minimize any potential for leakage. Furthermore, the mounting system 100, or each mounting apparatus 110, operates as a shingle which guides water off of the roof 310 to protect against leakage. The mounting system 100 is also designed to withstand high wind loads.

As will be described below, the mounting apparatuses 110 are each secured to the roof 310 using fasteners 121 (e.g., screws, bolts, nails, adhesive, or the like). Furthermore, the mounting apparatuses 110 are coupled to each other without hardware. Specifically, each mounting apparatus 110 is coupled to the mounting apparatus 110 above/below it and to the mounting apparatus 110 on either side of it via cooperating structures thereof without the use of additional mounting hardware or fasteners such as screws, nails, adhesive, or the like. The mounting apparatuses 110 are positioned on the roof 305 such that mounting apparatuses 110 that are higher up on the roof 305 surface are partially stacked atop the mounting apparatuses 110 that are lower down on the roof 305 surface similar to the manner in which shingles are layered onto a roof. Stated another way, there is some overlap between the mounting apparatuses 110 that are higher up on the roof 305 and the mounting apparatuses 110 that are lower down on the roof 305 to facilitate the flow of rainwater off of the roof 305.

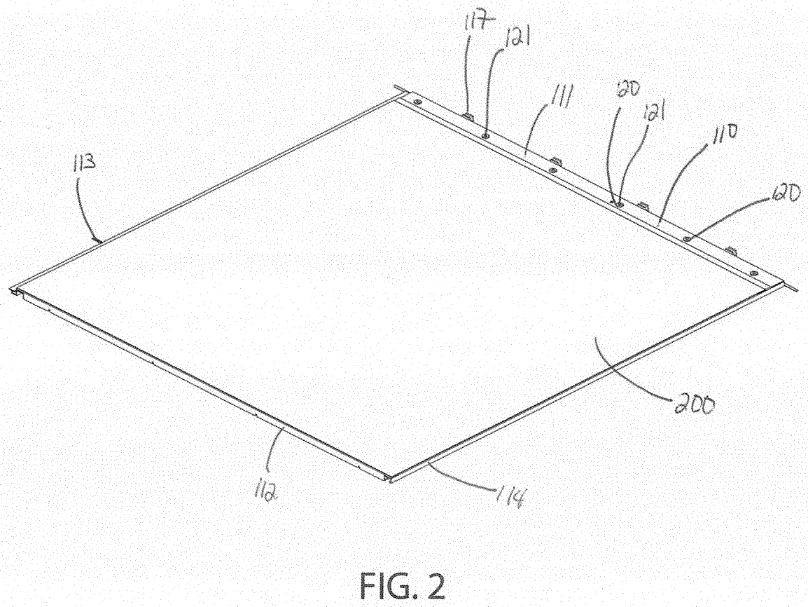

FIG. 2 illustrates one of the mounting apparatuses 110 with one of the solar panels 200 coupled thereto. Although described and illustrated herein as being used to mount the solar panels 200 to the roof 310 of the building 300, the invention is not to be so limited and the mounting system 100 may be used to mount the solar panels 200 to other building surfaces, such as sidewall surfaces of a building, chimneys, foundational structures that are distinct from any buildings, or the like. In certain example embodiments, the mounting system 100 is used to for mounting the solar panels 200 to a composite roof.

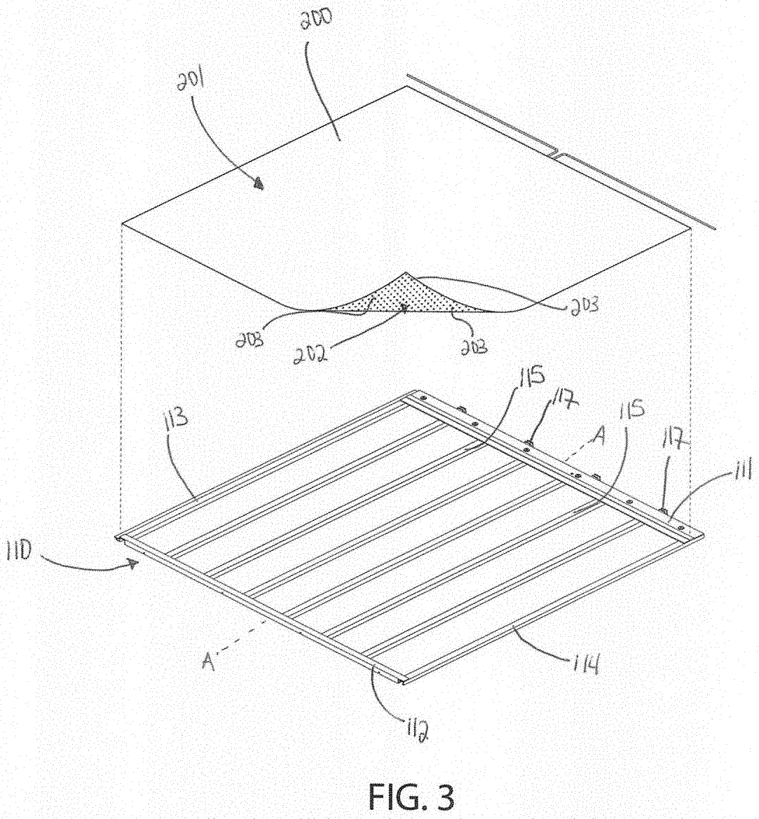

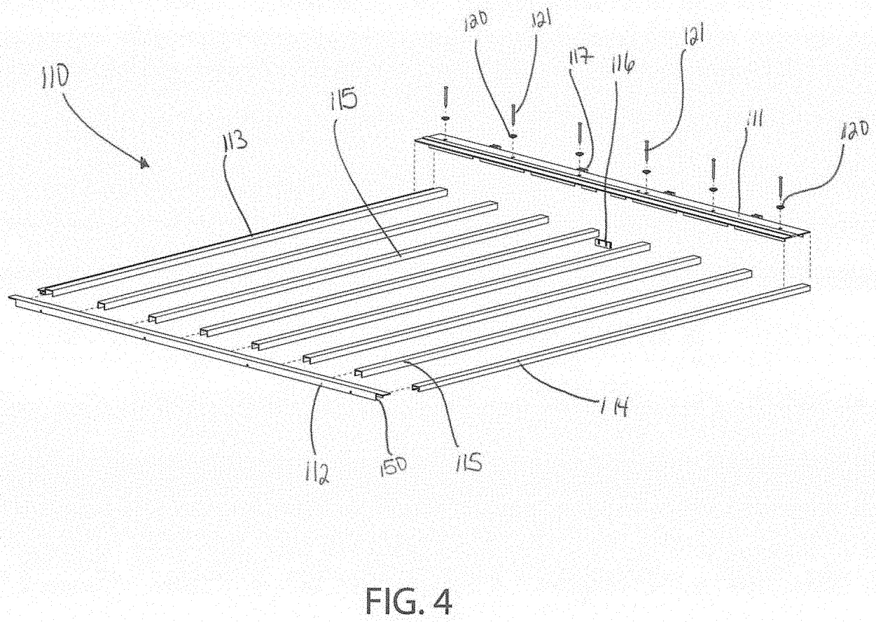

Referring to FIGS. 3-6 concurrently, the mounting apparatus 110 will be described in greater detail. The mounting apparatus 110 comprises a top bar 111, a bottom bar 112, a first side bar 113, a second side bar 114, and a plurality of elongated ribs 115 extending between the top bar 111 and the bottom bar 112. The first and second side bars 113, 114 also extend between the top and bottom bars 111, 112. Specifically, the top bar 111, the bottom bar 112, the first side bar 113, and the second side bar 114 collectively form the outer boundary of the mounting apparatus 110, and the elongated ribs 115 provide support and strength to the mounting apparatus 110 and provide a location on which the solar panel 200 can be mounted. The lengths of the first and second side bars 113, 114 and the elongated ribs 115 may be adjusted (increased or decreased) so that different size solar panels 200 may be secured to the mounting apparatus 110. The mounting apparatus 110 extends along a longitudinal axis A-A that is the direction that the first and second side bars 113, 114 and the elongated ribs 115 are elongated.

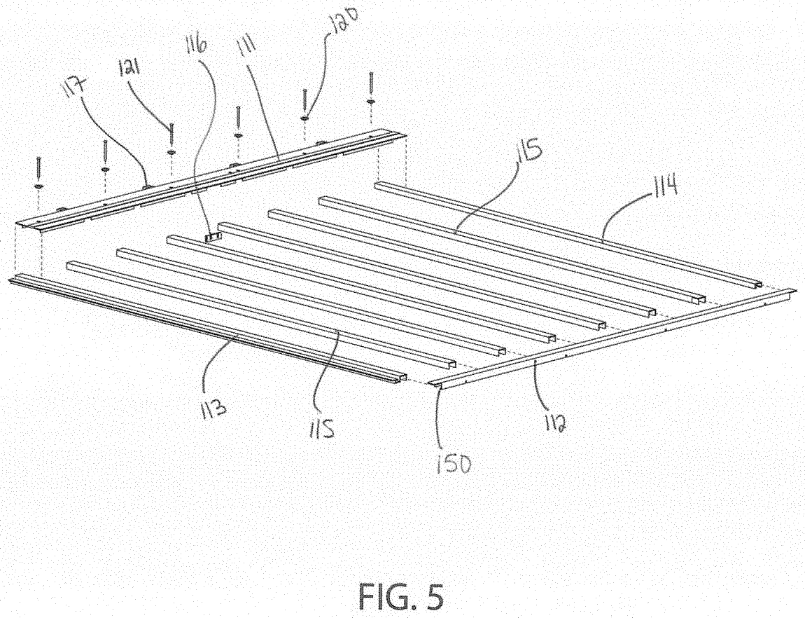

The mounting apparatus 110 also includes a cable guide 117 and a cable lock 116 (which may be formed of polycarbonate in one embodiment) for securing electrical cables in place. Specifically, the cable guide 117 comprises a plurality of spaced apart guide components that include a channel within which the electrical cables can be inserted to maintain them in an orderly fashion. The cable lock 116 is a unitary component including channels therein for the electrical cables to pass through. FIG. 6, which is a bottom view of the mounting apparatus 110, shows the cable guide 117 and the cable lock 116 in use retaining an electrical cable that extends from a junction box 118.

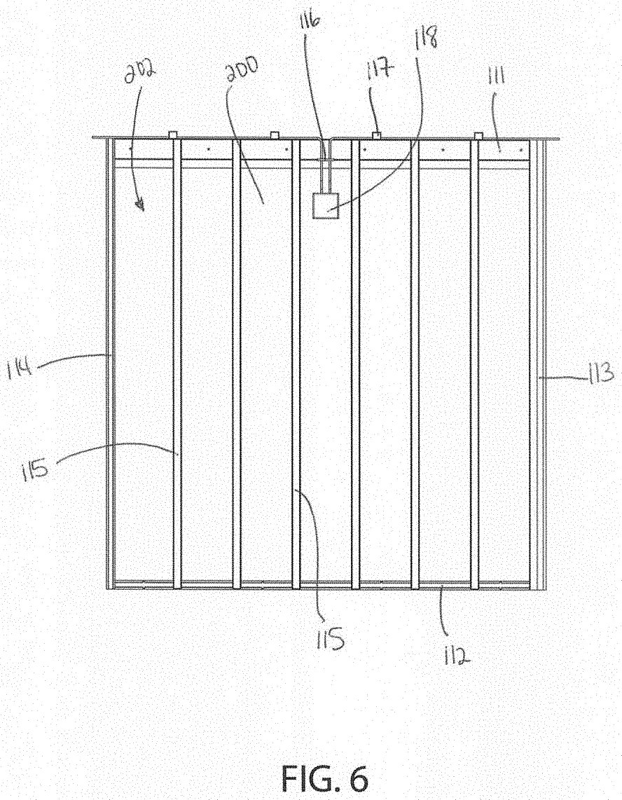

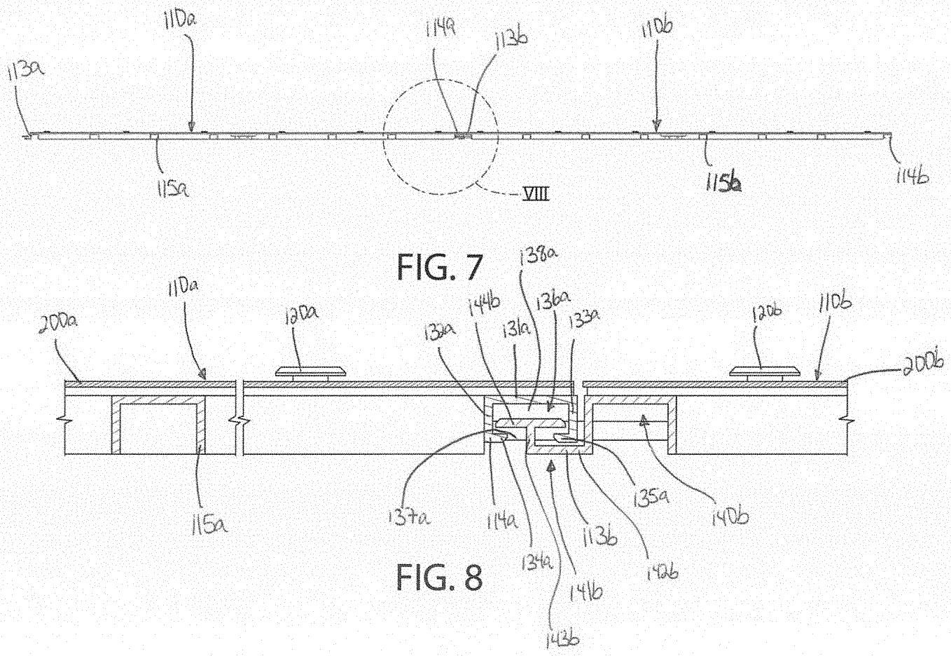

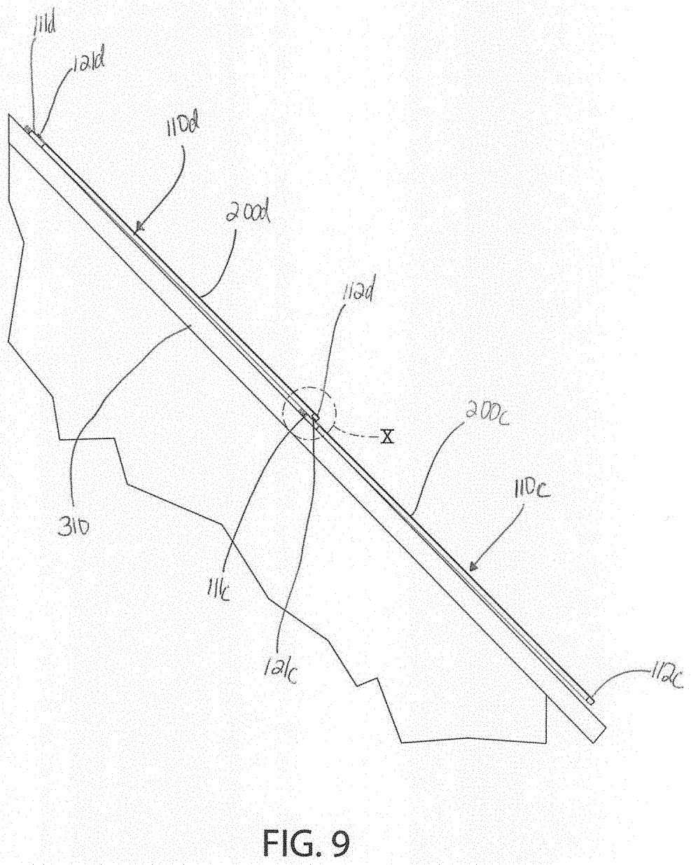

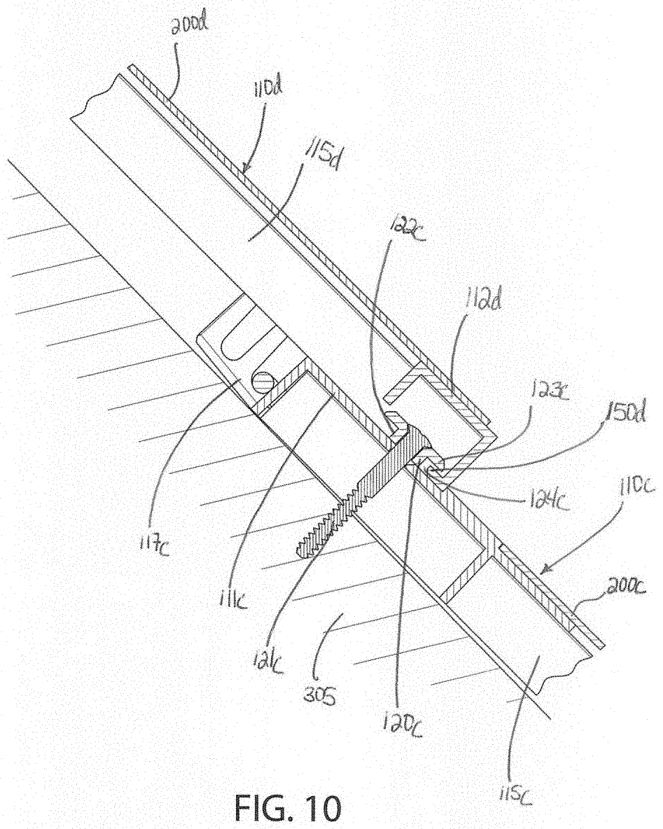

The mounting apparatus 110 also includes a locking cap 120 and a fastener 121. The fastener 121 extends through holes in the top bar 111 and penetrates into the roof 305 to secure the mounting apparatus 110 to the roof 305. The locking cap 120 is located between the fastener 121 and the top bar 111 and permits a hardware-free coupling between adjacently positioned mounting apparatuses 110. Specifically, the bottom bar 112 of a first one of the mounting apparatuses 110 engages the locking cap 120 of a second one of the mounting apparatuses 110 to couple the first and second ones of the mounting apparatuses 110 together as discussed in greater detail below with reference to FIGS. 9 and 10. The first and second bars 113, 114 have cooperating features that permit the first bar 113 of a first one of the mounting apparatuses 110 to be coupled to the second bar 114 of a second one of the mounting apparatuses 110 without additional hardware as discussed in greater detail below with specific reference to FIGS. 7 and 8. Thus, each of the mounting apparatuses 110 is coupled to the mounting apparatuses 110 above and below it and to the mounting apparatuses 110 adjacent to it.

In the example embodiment, the top bar 111 and the bottom bar 112 are formed via injection molding. In one non-limiting embodiment, the top bar 111 and the bottom bar 112 may be formed of a polycarbonate. Furthermore, in the example embodiment the first side bar 113, the second side bar 114, and the elongated ribs 115 are formed via an extrusion process. In one non-limiting embodiment, the first side bar 113, the second side bar 114, and the elongated ribs 115 may be formed of polyvinyl chloride (PVC). Of course, the invention is not to be limited by these manufacturing techniques in all embodiments and alternatives are possible within the scope of the disclosure set forth herein.

As shown in FIG. 3, the solar panel 200 has a front surface 201 and a rear surface 202. The front surface 201 is the surface of the solar panel 200 that is exposed to sunlight to enable the solar panel 200 to convert light to electric energy. The rear surface 202 of the solar panel 200 is coupled to the mounting apparatus 110. In the example embodiment, an adhesive 203 is applied to the rear surface 202 of the solar panel 200 to facilitate coupling of the solar panel 200 to the mounting apparatus 110. The adhesive 203 is illustrated in a dot-matrix pattern, although the invention is not to be particularly limited by the particular dot-matrix pattern illustrated and the adhesive 203 may be applied in other patterns as desired so long as it is ensured that the solar panel 200 is adequately secured to the mounting apparatus 110. The adhesive 203 is preferably a flexible adhesive, such as an elastomeric polymer, that permits the solar panel 200 to have some movement after being coupled to the mounting apparatus 110 so that as the solar panel 200 expands/contracts due to exposure to the elements it remains securely coupled to the mounting apparatus 110. Thus, the solar panel 200 seemingly floats atop the mounting apparatus 110 (although it is secured thereto with the adhesive 203) without using added hardware so that there is no stress to the solar panel 200 from expansion and contraction thereof.

The solar panel 200 can be any type of device used for converting light into electricity using semiconducting materials that exhibit the photovoltaic effect. In certain embodiments, the solar panels 200 may be formed of a flexible material having a thickness between 2-10 mm, more specifically between 2-5 mm, and still more specifically between 2-3 mm, although thicknesses outside of these ranges may also be used in other embodiments. In some embodiments, the solar panels 200 comprise a stainless steel foil onto which a thin film is sputtered. Of course, other materials may be used in alternative embodiments. The solar panel 200 is described herein as being flexible, which means that it is not rigid and is sufficiently pliable so that it can conform to a surface upon which it is mounted. Thus, the solar panel 200 can fit around curved structures and bend without breaking or deteriorating performance.

FIGS. 7 and 8 illustrate the connection between two mounting apparatuses of the mounting system 100 of FIG. 1 that are adjacent to one another in a side-by-side manner, namely a first mounting apparatus 110a and a second mounting apparatus 110b. The features of the first mounting apparatus 110a will be designated and described herein with the suffix “a” and the features of the second mounting apparatus 110b will be designated and described herein with the suffix “b” for ease of understanding. As can be seen, the first and second mounting apparatuses 110a, 110b are positioned adjacent to one another with the second side bar 114a of the first mounting apparatus 110a adjacent to the first side bar 113b of the second mounting apparatus 110b. The solar panel 200a is coupled to and floats atop the first mounting apparatus 110a and the solar panel 200b is coupled to and floats atop the second mounting apparatus 110b in the manner described above.

The second side bar 114a of the first mounting apparatus 110a engages the first side bar 113b of the second mounting apparatus 110a to couple the first and second mounting apparatuses to one another. Specifically, the second side bar 114a of the first mounting apparatus 110a comprises a main leg 131a and first and second legs 132a, 133a extending downwardly from the main leg 131a in a spaced apart manner and defining a channel 136a therebetween. Furthermore, the second side bar 114a comprises first and second flanges 134a, 135a extending respectively from the first and second legs 132a, 133a inwardly towards the channel 136a. The channel 136a comprises an entry section 137a transversely aligned with the first and second flanges 134a, 135a and a nesting section 138a.

The first side bar 113b of the second mounting apparatus 110b comprises a rib portion 140b and a connection portion 141b. The connection portion 141b extends from an outer surface of the rib portion 140b in a direction away from the second mounting apparatus 110b. Specifically, the connection portion 141b comprises a first leg 142b extending from the rib portion 140b, a second leg 143b extending upwardly from the first leg 142b, and a flange portion 144b that overhangs the second leg 143b on opposing sides thereof.

The flange portion 144b of the first side bar 113b of the second mounting apparatus 110b is sized and shaped to fit within the nesting section 138a of the channel 136a of the second side bar 114a of the first mounting apparatus 110b while the second leg 143b of the first side bar 113b of the second mounting apparatus 110b is located within the entryway section 137a of the channel 136a of the second side bar 114a of the first mounting apparatus 110b. The first side bar 113b of the second mounting apparatus 110b can only be coupled to the second side bar 114 of the first mounting apparatus 110b by sliding the first and second mounting apparatuses 110a, 110b relative to one another in the direction of the longitudinal axis A-A. This is because the flange portion 144b of the first side bar 113b of the second mounting apparatus 110b has a greater dimension than the entryway section 137a of the channel 136a of the second side bar 114a of the first mounting apparatus 110a.

Thus, the flange portion 144b of the first side bar 113b cannot be slide into the channel 136a of the second side bar 114a via movement in a direction transverse to the longitudinal axis A-A. Similarly, the flange portion 144b of the first side bar 113b can only be removed from the channel 136a of the second side bar 114a via relative movement of the first and second mounting apparatuses 110a, 110b in a direction of the longitudinal axis A-A. Interference between the flange portion 144b of the first side bar 113b of the second mounting apparatus 110b and the flanges 134a, 135a of the second side bar 114a of the first mounting apparatus 110a prevents separation of the first and second side bars 113b, 114a of the first and second mounting apparatuses 110a, 110b via movement transverse to the longitudinal axis A-A.

Thus, adjacent ones of the mounting apparatuses 110 can be coupled together by a sliding engagement between the first side bar 113 of one of the mounting apparatuses 110 and the second side bar 114 of the other one of the mounting apparatuses 110 in a direction of the longitudinal axis A-A. The adjacent mounting apparatuses 110 can then only be separated by relative sliding in the direction of the longitudinal axis A-A due to mating features of the first and second side bars 113, 114. Furthermore, because each of the mounting apparatuses 110 is separately secured to the roof or other surface to which it is mounted as described below, the mounting apparatuses 110, remain locked together to create the full mounting system or assembly 100.

Referring to FIGS. 9 and 10, the manner in which each of the mounting apparatuses 110 is coupled to the roof 310 as well as the manner in which the mounting apparatuses 110 having their top and bottom bars 111, 112 adjacent to one another are coupled together will be described. Specifically, FIGS. 9 and 10 illustrate a third mounting apparatus 110c and a fourth mounting apparatus 110d. The features of the third mounting apparatus 110c will be designated and described herein with the suffix “c” and the features of the fourth mounting apparatus 110d will be designated and described herein with the suffix “d” for each of understanding.

In FIGS. 9 and 10, the third and fourth mounting apparatuses 110c, 110d are secured to the roof 305. Furthermore, the fourth mounting apparatus 110d is coupled to the third mounting apparatus 110d to create the mounting system 100 whereby each mounting apparatus 110 is coupled to the mounting apparatus that are adjacent to it. Specifically, referring to FIGS. 1, 8, and 10, mounting apparatuses that are adjacent to one another in a row (i.e., at the same height along the roof 305) are coupled together via cooperation between their first and second side bars 113, 114 (as described above with reference to FIGS. 7 and 8) and mounting apparatuses 110 that are adjacent to one another in a column (i.e., at different heights along the roof 305 but in alignment along the longitudinal axis A-A) are coupled together via cooperation between their top and bottom bars 111, 112 (as described below with specific reference to FIG. 10). Each mounting apparatus 110 is also coupled directly to the roof 305 via the fasteners 121.

As shown in FIG. 10, the third mounting apparatus 110c is secured to the roof 305 by a plurality of the fasteners 121c. Specifically, the fasteners 121c are each inserted into an opening in the top bar 111c and extend through the top bar 111c and into the roof 305. The locking cap 120c is positioned between the fastener 121c and the top bar 111c such that the fastener 121c secures the locking cap 120c to the top bar 111c. The locking cap 120c has a body portion 122c and an annular flange 123c extending radially from the body portion 122c. The annular flange 123c of the locking cap 120c is spaced apart from the top bar 111c by a gap 124c.

The fourth mounting apparatus 110d is coupled to the third mounting apparatus 111c via engagement between the bottom bar 112d of the fourth mounting apparatus 110d and the locking cap 120c. Specifically, the bottom bar 112d of the fourth mounting apparatus 110d has a hook portion 150d such that the fourth mounting apparatus 110d can be translated so that the hook portion 150d of the bottom bar 112d of the fourth mounting apparatus 110d enters into the gap 124c between the annular flange 123c of the locking cap 120c and the top bar 111c of the third mounting apparatus 110c. Furthermore, the opposite end of the fourth mounting apparatus 110d (i.e., the top bar 111d of the fourth mounting apparatus 110d illustrated in FIG. 9 but not in FIG. 10) is secured directly to the roof 305 using fasteners 121d in the same manner that the third mounting apparatus 110c is secured to the roof 305 as described above.

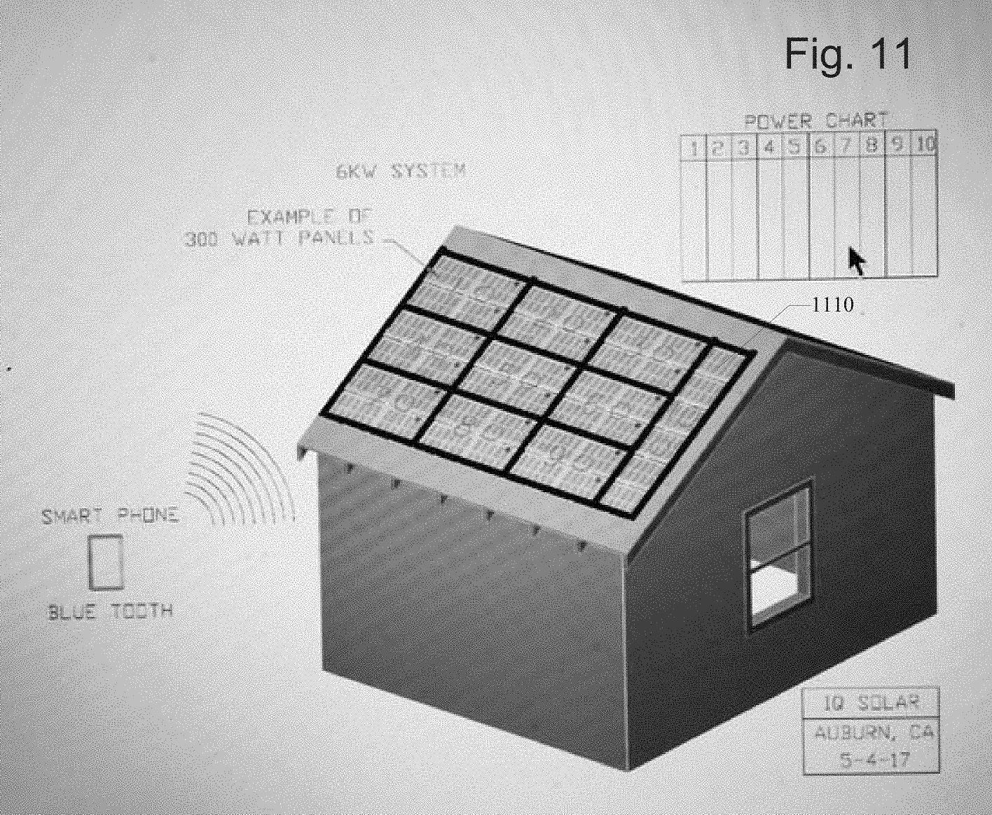

FIG. 11 is an example embodiment illustrating the solar panel auto-populate feature showing how to maximize the solar panel area on a roof using the solar panel mounting system and control system of an example embodiment. In an example embodiment, thin-film, flexible solar panels can be installed on a roof (or other surface) of a structure. As described above, these flexible solar panels can be flexible copper indium gallium selenide (CIGS) thin-film photovoltaic panels, which are manufactured by MiaSolé™ of Santa Clara, Calif. MiaSolé's manufacturing process lays CIGS on a flexible stainless steel substrate and produces all layers of photovoltaic material in a continuous sputtering process, thereby producing efficient thin-film, flexible solar panels. Unlike the conventional rigid solar panels, flexible solar panels can be more conveniently sized to accommodate portions of a roof (or other surface) that would otherwise not be useable with a rigid solar panel. For example as shown in FIG. 11, area 1110 of the roof of a structure would be too narrow to accommodate a conventional rigid solar panel. However, by using thin-film, flexible solar panels, area 1110 can be fitted with a differently shaped or differently sized solar panel, relative to the other solar panels on the roof. Moreover, the solar panel mounting apparatus, as described above, can be used to provide a stable, water-resistant, easily-installed, and safe mounting structure for the differently shaped or differently sized solar panel installed in area 1110. Additionally, the solar panel protection and control system described in the referenced priority patent application can be used to manage the power output produced by the array of solar panels shown in FIG. 11, including the differently shaped or differently sized solar panel installed in area 1110. As a result, the solar panel control and mounting systems described herein and in the referenced priority patent application can be used to install and control solar panel arrays with individual solar panels of varying sizes or shapes and solar panel arrays including thin-film, flexible solar panels.

Using the inventive mounting system 100 described herein, the installation of an entire solar panel system on a standard sized roof may be completed in a single day. This represents a significant decrease from current technologies that take several days to install, which results in a significant decrease in labor costs. Because the mounting apparatuses 110 snap and slide together without hardware, the assembly of the mounting system 100 is quite simple.

While the present disclosure describes several embodiments, these embodiments are to be understood as illustrative and do not limit the claim scope. The structures and methods disclosed in this patent application can have many variations and modifications. Having thus described example embodiments of the present invention, it will be apparent to one of ordinary skill in the art that various modifications can be made within the spirit and scope of the present invention. Accordingly, the scope of the invention should be determined not by the embodiments illustrated, but by the appended claims and their legal equivalents.

What is claimed is:

1. A solar panel mounting system comprising:
a top bar;
a bottom bar;
a first side bar;
a second side bar;
a plurality of elongated ribs extending between the top bar and the bottom bar, the first and second side bars extending between the top and bottom bars, the top bar, the bottom bar, the first side bar, and the second side bar collectively forming an outer boundary of the mounting system, and the elongated ribs providing support and a location on which a solar panel can be mounted; and
a solar panel attached to the plurality of elongated ribs with a flexible adhesive.

2. The solar panel mounting system of claim 1 wherein the solar panel is a thin-film, flexible solar panel.

3. The solar panel mounting system of claim 1 including a cable guide and a cable lock.

4. The solar panel mounting system of claim 1 including a locking cap and a fastener.

5. The solar panel mounting system of claim 1 wherein the top bar and the bottom bar are formed via injection molding.

6. The solar panel mounting system of claim 1 wherein the second side bar of a first mounting apparatus is configured to engage the first side bar of a second mounting apparatus.

7. The solar panel mounting system of claim 1 wherein the second side bar includes a main leg and first and second legs extending downwardly from the main leg to define a channel.

8. The solar panel mounting system of claim 7 wherein the second side bar includes first and second flanges extending respectively from the first and second legs inwardly toward the channel.

9. The solar panel mounting system of claim 1 wherein the first side bar includes a rib portion and a connection portion.

10. The solar panel mounting system of claim 1 being configured to enable adjacent ones of the mounting system to be coupled together by a sliding engagement between the first side bar of a second mounting apparatus and the second side bar of a first mounting apparatus.

11. The solar panel mounting system of claim 1 including a junction box, the junction box including a solar panel protection and control system comprising:
a measurement block to measure the parameters of a solar panel;
a protection switch to connect or disconnect the solar panel to other solar panels, the measurement block positioned in series between the solar panel and the protection switch to enable the measurement block to measure the parameters of the solar panel even when the protection switch has disconnected the solar panel;
a bypass block to bypass the solar panel when the protection switch is disconnected;
a test block to measure the maximum power point of the solar panel using the Maximum Power Law, the test block configured to calculate the gradient of the voltage-current curve of the solar panel;
a communication block to communicate with an external control unit; and
a control block to control the measurement block, the protection switch, the test block, and the communication block, whereby the solar panel can be bypassed under predetermined situations or under command of the external control unit, the control block positioned in series between the solar panel and the protection switch to enable the control block to receive power from the solar panel even when the protection switch has disconnected the solar panel.

12. The solar panel mounting system of claim 11 wherein the measurement block measures the temperature, voltage, current, or any combination of thereof of the solar panel, and the test block measures the maximum power point of the solar panel.

13. The solar panel mounting system of claim 11 wherein the bypass block is a Schottky diode.

14. The solar panel mounting system of claim 11 wherein the measurement block, the protection switch, the bypass block, the test block, the communication block and the control block are resident in the J-Box of the solar panel.

15. The solar panel mounting system of claim 11 wherein the protection switch is a relay, a NMOS, a PMOS, a PNP BJT, a NPN BJT, a IGBT, a SCR, or any combination of thereof.

16. The solar panel mounting system of claim 11 wherein the control block controls the protection switch to bypass the solar panel when at least one parameter of the solar panel measured by the measurement block equals a predetermined value, or when the control block is powered on for the first time, or when a turning-on command is not received for longer than a predetermined period of time during operation.

17. The solar panel mounting system of claim 11 wherein the communication block has its unique address and communicates with the external control unit using DC power line communication, Wifi, Bluetooth, or a Zigbee communication method.

18. The solar panel mounting system of claim 11 wherein the external control unit is a smart phone.

19. The solar panel mounting system of claim 11 wherein the measurement block further comprises an arc fault detection block to detect an arc fault event by directly measuring the voltage of the solar panel, and checking if the voltage shows a predetermined arc fault signature.

20. The solar panel mounting system of claim 11 wherein the external control unit monitors the operation of the solar panel by communicating with the communication block to get the parameters including but not limited to the voltage, current, temperature, arc fault and maximum power point of the solar panel.
